(19) United States
(12) Patent Application Publication
(10) Pub. No.: US 2017/0256010 A1
(43) Pub. Date: Sep. 7, 2017

(54) PATENT ALERT SYSTEM

(71) Applicant: Allergan, Inc., Irvine, CA (US)

(72) Inventors: Anish Mohindru, Laguna Woods, CA (US); Rong Yang, Irvine, CA (US); Sean A. Bulloch, Orange, CA (US)

(21) Appl. No.: 15/452,212

(22) Filed: Mar. 7, 2017

Related U.S. Application Data
(60) Provisional application No. 62/304,545, filed on Mar. 7, 2016.

(51) Int. Cl. G06Q 50/18; G06F 17/30; G06Q 10/10

(52) U.S. Cl. CPC G06Q 50/184; G06Q 10/107; G06F 17/30867

(57) ABSTRACT

A computerized publication system comprising an automated alert generation platform for use in monitoring patents or other documents in the public domain, combined with a subscription management module.

### FIELD

The present disclosure relates to a publication alert system. In particular, the present disclosure relates to a patent alert system comprising an automated alert generation platform that processes data from multiple commercial databases, formats the data into pre-defined alert templates, and publishes alerts to subscribers at a predetermined cadence.

### BACKGROUND

As an innovation-driven industry, pharmaceutical company scientists file hundreds of new ideas each year. Even though this is a “good problem” to have, the challenge for the patent group is to efficiently evaluate the filed inventions in view of prior art, draft patent applications with broad and defensible claims, and prosecute the patent applications into grantable patents. Each of these activities relies heavily on timely and accurate patent and non-patent literature information. Timely delivery directly impacts the window of office actions, opposition deadlines, and other legal motions ruled by the docket. Accuracy defines the quality and efficiency with which the information can be digested and acted upon.

Though corporate libraries have various solutions at different times to deliver timely and accurate patent information, there is not a well-designed, single-point solution that meets all of criteria for data searching, data aggregation, electronic mail alert publishing, subscription management, and data storage. U.S. Pat. No. 7,984,168 issued to STG Interactive, entitled “Method and system for operation of a computer network intended for the publication of content” discloses a computer network operating method for data management, but lacks the ability of publishing based on subscription management. U.S. Pat. No. 6,122,633, issued to IMB Corporation, entitled “Subscription within workflow management systems”, discloses a workflow management system with subscription means involved, but lacks the feature of automatically extracting data and publishing in a fixed cadence. Similarly, U.S. Pat. No. 6,014,673, issued to Hewlett-Packard Company, entitled “Simultaneous use of database and durable store in work flow and process flow systems”, describes data storage in an object cache with the capability of querying and updating the current data, but lacks the ability of auto-publishing. Collectively, the prior art falls short of the inventive aspects of our disclosure herein.

Furthermore, an extensive market survey could not locate any “commercial off-the shelf” solution that satisfies the basic requirements of an automated patent alert system with the criteria described above.

Thus, there is a need for an automated patent alert system that processes data from multiple commercial databases, formats the data into pre-defined alert templates, and publishes alerts to subscribers at a predetermined cadence.

The patent alert system according to aspects of the present disclosure addresses this need, among other things, in a single, multi-functional platform.

### Definitions

As used herein, the words or terms set forth below have the following definitions:

Active Directory user group

Active Directory is the Microsoft service developed for Windows to store information about an individual computer network's components, such as user accounts, computer names, or user groups, which are aggregated into manageable units.

Alert

An electronic mail notification to subscribers delivering new content for subscribes categories and topics.

Category and topic

In the patent alert system, patent publications are classified by their general subject matter, called “categories”, such as therapeutic areas or drug classes, and then further divided into “topics”, such as specific diseases under a therapeutic area or a specific drug under a specific drug class.

Command language

The specific commands and syntax allowed by the online host to issue computerized instructions for actions such as “search” for information and “display” the information.

Commercial host system

Systems available to licensees that permit the licensee to search available databases for corresponding information, such as content present in, but not limited to, patent documents; also known as host online system, also known as database host, also known as database provider.

Confidential topic

A set of alerts whereby authorized users have access to these alert data, and the availability of said alerts is not disclosed to others.

Database

Collections of data, herein containing patent information.

Data parser

Systems that perform syntactic analysis of input data (including, but not limited to, text, numeric data, and graphics) to provide a structural representation of the input.

Electronic mail

A method of interpersonal or inter-system communication using digital transmission.

European Patent database

A public and freely-accessible patent database developed by European Patent Office (EPO) covering worldwide published patent application publications and patent publications and contains opposition proceedings and patent legal status events for European patents and patent applications.

HTML

Hyper Text Markup Language (HTML) is a standard programming language for creating web pages or web applications.

Java

A general-purpose computer programming language commonly utilized in web page design.

Keyword

Words or phrases which have great significance, such as those used in the search query.

Patent alert system

Patent alert system as used herein describes a computerized system for the automated delivery of publication (including, but not limited to, patent application publication, patent publication, and re-issue patent publication) alerts from a plurality of databases, on a plurality of topics to a plurality of users and with multi-functional, configurable settings.

Patent Cooperation Treaty database

A database entitled “PATENTSCOPE”, developed and published by Patent Cooperation Treaty (PCT) which provides full text access to all international PCT applications, as well as to patent documents of participating national and regional patent offices.

Patent document

Publicly accessible documents published by a national patent issuing authority in the course of a patent lifecycle, such as patent application publications, patent publications, re-issue patent publications, patent re-assignments, and patent term extensions.

Proxy

A person who has the ability and authority to act or represent another person.

Publication platform

Systems that allow for the creation, configuration, customization, and delivery of alerts.

Relational database

Databases structured to recognize relations and link information among stored pieces of data, allowing for compositional delivery.

Search query

A statement created for searching information comprising of keywords, operators, field designations, and host-system language properties

Software program

Part of a computer system that consists of the instructions required to operate a computer system, perform a computerized task, or allow a person to interact with a computerized system.

Subscriber

Individuals listed in the Active Directory who have the ability of selecting and de-selecting the alerts listed on the subscription page.

Subscription page

A web-based online page that allows for individual topic description, topic selection, and de-selection.

### SUMMARY

In one aspect, the present disclosure is directed to an alert system comprising an automated alert generation platform that processes data from multiple commercial databases, formats these data into pre-defined alert templates, and publishes electronic mail alerts to one or more users at a predetermined cadence. In some embodiments, the present alert system is a patent alert system. In some embodiments, the present alert system comprises a first module designed for alert data identification, parsing, and loading; a second module designed for alert configuration data, formatting, and alert delivery; and a third designed for alert subscription management. In some embodiments, the data include patent-related data. In alternative embodiments, the alert system of the present disclosure is used to process, format, and publish non-patent data, such as journal articles, clinical trial information, and news stories.

In another aspect, the present disclosure provides a method of publishing alert data from a patent alert system to a subscriber, comprising the steps of:
(a) retrieving alert data from an on-line host system through a search query at a pre-defined cadence;
(b) extracting data elements from the retrieved alert data through a data parser;
(c) reformatting the extracted data elements into a pre-defined template through a publication platform;
(d) assigning reformatted alert data with the appropriate categories and topics through a module designed for alert configuration and publication; and
(e) delivering to the subscriber the reformatted alert data with category and topic titles through a module configured for alert electronic mail generator and subscription management.

### BRIEF DESCRIPTION OF THE FIGURES

The following drawings are presented to illustrate aspects and features of embodiments of the present invention.

FIG. 1 illustrates an overview of a patent alert system according to one aspect of the present disclosure.

### DESCRIPTION

Aspect of the present disclosure provides an alert system comprising an automated alert generation platform that processes data from multiple commercial databases, formats these data into pre-defined alert templates, and publishes electronic mail alerts to one or more users at a predetermined cadence.

In one aspect, the present patent alert system is a single-point solution with a plurality of functions. These functions include, but are not limited to, data searching, data aggregation, electronic mail alert delivery, and subscription management.

In some embodiments, the present disclosure relates to a patent alert system which is a single-point solution for data searching, data aggregation, electronic mail alert publishing, and subscription management. In some embodiments, it comprises but is not limited to, the functions and features of:
allowing for multiple online alerts independent of query structure or strategy
sending result by electronic mail to designated computers for further processing
allowing for data from multiple patent databases to be aggregated in a staging and publication area of the patent alert system
parsing all desired data to unique elements, such as the title, individual inventors, assignees, patent expiration dates, etc.
allowing for manual or automated delivery to subscribers
presenting a web-based subscription form with hierarchical categories and topics
enabling subscribers to select all available or individual topics in each category
allowing for “confidential” topics only visible to pre-authorized individuals
allowing inserted commentary, including text from claims, for review by subscribers
packaging data in summary tables with information such as the patent document title, appropriate patent numbers, and patent assignees
containing a link that redirects to full text of the patent document
enabling scalability by virtue of the number of subscribers, the number of topics, the number of queried databases

In some embodiments, the present system comprises three modules that are interconnected by electronic mail, computer networks, and other communication modalities. In some embodiments, the system comprises additional modules. In one embodiment, the system is a patent alert system consisting of three modules interconnected by electronic mail, networks, and other communication modalities.

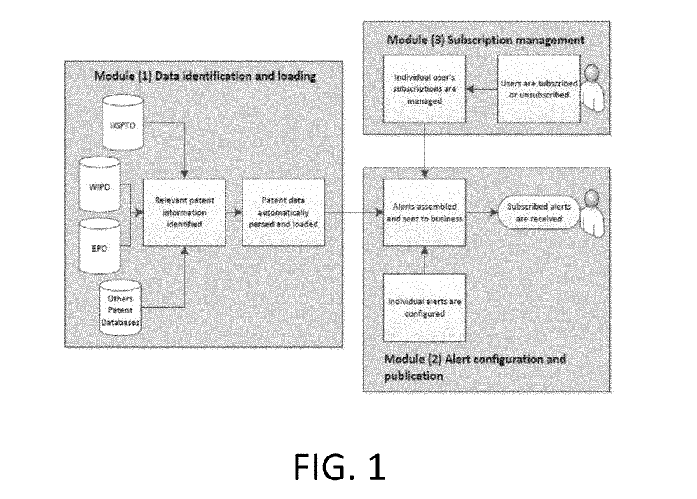

An exemplary and non-limiting embodiment of a patent alert system in accordance with aspects of the present disclosure is shown in FIG. 1. This specific embodiment is designed and developed for the described utility. This system is scalable, customizable, and allows users to manage their own subscriptions.

As shown in the exemplary embodiment illustrated in FIG. 1, prior to the automated operation of module (1), there is a discovery phase, whereby data requirements are obtained:

a. Change of patent legal status

b. New national filings

c. New uses or formulations

d. Re-examination or re-assignment

e. New chemical, biological, or device entities

f. Competitive intelligence

Complex search queries are created in a target on-line host system. The search queries contain specific subject matter-related information and are designed to identify subject-related data. The search queries may be amended to optimize recall or precision or to add new information.

All data are stored in the publication platform. Prior to the search query creation, the publication platform is configured. Unique proprietary codes are generated to allow for association of the data with a specific publication alert and/or topic. Additionally, unique data elements that could be contained in the result's compressed file are identified and recorded.

### Module (1) Data Identification, Parsing, and Loading

The target on-line host system performs a periodic information update. For example, the United States Patent and Trademark Office (hereinafter “USPTO”) typically posts updates every Tuesday. The search query is run at a pre-defined cadence and is timed to identify new data based on this periodic information update. Typically, the data are delivered in the form of an electronic mail containing an HTML hyperlink pointing to the result's compressed file, which is stored on the on-line host system computers. The data in the form of electronic mail is delivered to a designated electronic mail address for processing. Subsequently, and according to the update schedule of the commercial host, additional data electronic mail packets may be generated from other databases, such as the European Patent and Patent Cooperation Treaty databases. This process continues for all the configured patent databases.

Module (1) comprises (in part) of a software program (herein called electronic mail monitor) that automatically monitors a designated electronic mail address. When a new electronic mail containing data is received, the electronic mail monitor program parses the electronic mail, extracts the HTML hyperlink, and downloads the compressed file to a temporary storage location on the module (1) computer. The unique proprietary codes associated with the data electronic mail are appended to the downloaded compressed file's name.

A data integration and parsing software (herein called data parser) is pre-configured with proprietary algorithms to isolate unique data elements, such as patent numbers, patent kind codes, expiration dates, and graphic images. Multiple algorithms may be generated depending on the initial data source or type. At a pre-defined cadence, the data parser checks for compressed files in the temporary storage location on the module (1) computer. When compressed files are identified, all unique data elements contained with the file are extracted and loaded into the publication platform's relational database data storage system and the data is associated with the unique proprietary codes listed in the compressed file's name. Additional individual data elements may be manually added to the relational database data storage system as needed.

### Module (2) Alert Configuration, Formatting, and Delivery

Module (2) comprises (in part) of a software program (herein called publication platform) that allows for the creation and configuration of the publication alerts. Access is limited to specified publication platform administrators and is controlled via an Active Directory user group security model.

Publication alerts, categories, topics, fields, and keywords are all generated and maintained in this system. Publication alerts can be associated with one or more categories. categories can be associated with one or more topics. Topics may be associated with one or more fields. Fields may be associated with one or more individual data elements. Keywords, which allow for specific text highlighting, may also be associated with associated with one or more individual data elements.

Topics have two publication settings: “manual” or “automatic”. Manual publication topics require a publication platform administrator to manually screen, modify as needed, and select specified data for publication alert inclusion. Data deemed not appropriate are flagged as deleted in the relational database data storage system. Once all candidate data are selected, the publication alert is associated with the publication alert subscriber base and flagged for delivery. For automatic publication topics, all data loaded is automatically and selected for publication alert inclusion. No manual screening or deletion of the data is performed. Once all data are loaded, the publication alert is automatically associated with the publication alert subscriber base and flagged for delivery.

The publication platform allows for the creation of custom publication alert templates. Templates are coded in HTML and contain Java-based data variable pointers to the individual data elements stored in the relational database data storage system. These Java-based variable pointers allow for dynamic population of the specified individual data elements into the template for delivery in the publication alert. The Java-based variable data pointers can handle multiple data types/formats, including but not limited to, text, numbers, and graphic images.

Module (2) also comprises (in part) of a software program (herein called alert electronic mail generator) which runs at a set cadence to check for publication alerts flagged for delivery. When items are identified, the alert electronic mail generator generates a list of all subscribers and creates the publication alert based on each subscriber's profile selections and the publication alert template. The publication alerts are then sent via electronic mail to the subscriber.

### Module (3) Subscription Management

Module (3) comprises of an alert subscriber-facing graphical interface web page (herein called subscription page), which displays all available publication alerts available in the publication platform. Users can select and manage which publication alerts and topics they wish to receive. Access is controlled and authenticated via the user's Active Directory profile. Key user data elements such as first and last name and electronic mail address are used to create or display (if already existing) the specific user's profile stored in the publication platform. Users can select (i.e. subscribe) or de-select (i.e. unsubscribe) from publication alerts or topics as needed. Selection is controlled via radio-button selections at the publication alert, category, or topic level. Changes or updates are saved in the user's profile in the publication platform.

Topics can be designated as “confidential” and will only be display for authorized users. Display of confidential topics is controlled and authenticated via the user's Active Directory profile.

Publication platform administrators can also “proxy” into another user's account via the subscription page. A search can be performed to identify any user's profile. Upon selection, the user's profile by proxy is loaded on the subscription page.

### EXAMPLES

The following non-limiting example provides those of ordinary skill in the art with specific preferred systems and within the scope of embodiments of the present invention and are not intended to limit the scope of the invention.

### Example 1

Create a new patent alert for patent documents containing the term “asthma”.

Step 1. Query formation (also referred to as building queries)

Identify all terms that signify the idea of “asthma”. Use published taxonomies, such as Medical Subject Headings (MeSH) from on the web.

Proposed query: “asthma or asthmatic or bronchoconstriction or breathing disorder or asthmaticus or paroxysmal or dyspnea”.

Step 2. Identify target databases

Databases: US Patents, European Patents, Patent Cooperation Treaty Patents.

Step 3. Configure query online

Enter database host system with authentication codes and configure search statement in each database using the proprietary command language of the selected online host.

Step 3. Set up alert

Establish the online alert using the method of the target online host.

Step 4. Configure publication platform

Determine the category, topic, and other configurable elements, including the template.

Step 5. Gather subscriptions

Receive subscriptions for the new alert via the subscription form.

Step 6. Receive alert

At specified cadence, the newly updated data are available from the host system. The data are processed as described herein and as shown in FIG. 1.

Step 7. Deliver alerts

Electronic mails are created containing newly available information to the topic of “asthma”. The electronic mails are delivered to all users who have subscribed to this topic. The subscribers receive the electronic mail in their mailbox. The electronic mail is opened and the new data are reviewed. An optional hyperlink allows the users to view additional information on a patent at select web sites.

Many alterations and modifications may be made by those having ordinary skill in the art, without departing from the spirit and scope of the disclosure. Therefore, it must be understood that the described embodiments have been set forth only for the purposes of examples, and that the embodiments should not be taken as limiting the scope of the following claims. The following claims are, therefore, to be read to include not only the combination of elements which are literally set forth, but all equivalent elements for performing substantially the same function in substantially the same way to obtain substantially the same result. The claims are thus to be understood to include those that have been described above, those that are conceptually equivalent, and those that incorporate the ideas of the disclosure.

1. A patent alert system, comprising:
a first module designed for alert data identification, parsing, and loading;
a second module designed for alert configuration data, formatting, and alert delivery; and
a third module designed for alert subscription management.

2. The system of claim 1, wherein the first module is implemented through a pre-configured data parser, wherein data from an on-line host system is extracted into unique data elements, and loaded to the second module for further configuration.

3. The system of claim 2, wherein the data from the on-line host system is obtained through a search query.

4. The system of claim 2, wherein the on-line host system comprises one or more databases.

5. The system of claim 4, wherein data obtained from the one or more databases is de-duplicated by the first module.

6. The system of claim 2, wherein the first module further comprises an electronic mail monitor.

7. The system of claim 6, wherein the electronic mail monitor automatically monitors a designated electronic mail address, extracts hyperlinks embedded in the mail and downloads the compressed file to the data parser.

8. The system of claim 2, wherein additional alert data elements are manually added to the first module and loaded to the second module.

9. The system of claim 1, wherein the second module comprises:
a publication platform; wherefrom an alert publication is generated using data elements extracted by the first module, formatted according to a pre-defined template, and entitled with appropriate categories and topics; and
an alert electronic mail generator, wherein the alert electronic mail generator runs at a set cadence to identify publications flagged for being delivered, and readies the identified publications for delivery.

10. The system of claim 9, wherein the publication platform further comprises a unit for publication setting wherein manual publications are separated from automatic publications, and are further filtered and processed before delivery.

11. The system of claim 1, wherein the third module comprises a user-interface.

12. The system of claim 11, wherein the user-interface comprises a webpage displaying alert publications generated from the publication platform; and wherein the alert publications are selectable by a subscriber.

13. The system of claim 11, wherein access to the user-interface webpage is controlled and authenticated via the subscriber's profile.

14. The system of claim 13, wherein the subscriber's profile comprises first and last name, electronic mail address, title, departments, office location, phone numbers, or combinations thereof.

15. A method of publishing alert data from a patent alert system to a subscriber, comprising the steps of:
(a) retrieving alert data from an on-line host system through a search query at a pre-defined cadence;
(b) extracting data elements from the retrieved alert data through a data parser;
(c) reformatting the extracted data elements into a pre-defined template through a publication platform;
(d) assigning reformatted alert data with the appropriate categories and topics through a module designed for alert configuration and publication; and
(e) delivering to the subscriber the reformatted alert data with category and topic titles through a module configured for alert electronic mail generator and subscription management.

16. The method of claim 15, further comprising the step of building queries before the step of retrieving alert data from the on-line host system, wherein alert data requirements are obtained, a query or queries are proposed, and tested in pre-selected databases hosted by the on-line host system.

17. The method of claim 15, wherein alert delivery to the subscribers is an automatic process wherein the reformatted alert data is not further processed.

18. The method of claim 15, wherein alert delivery to the subscriber is a manual process wherein the reformatted alert data is further screened, filtered and edited.
